(19) United States
(12) Patent Application Publication
(10) Pub. No.: US 2019/0309466 A1
(43) Pub. Date: Oct. 10, 2019

(54) Laundry Transfer Contour for Side by Side Front Loading Washers and Dryers

(71) Applicant: Joel Darragh Fullmer, Interlaken, NJ (US)

(72) Inventor: Joel Darragh Fullmer, Interlaken, NJ (US)

(21) Appl. No.: 15/948,462

(22) Filed: Apr. 9, 2018

(51) Int. Cl. D06F 95/00

(52) U.S. Cl. CPC D06F 95/002; B65G 11/023

(57) ABSTRACT

This invention enables individuals, especially those differently-abled, doing laundry with Side by Side Front loading Washers and Dryers, to remove damp, heavy, bulky, lengthy, clingy, or entangled items from the Washer onto a Laundry Transfer Contour where they can be supported, contained, and guided to the Dryer. The Laundry Transfer Contour consists of: an open-ended trough with upturned front and rear edges, that spans the working distance beneath and between the appliance drum doors, without obstructing door operation, that is removable from the Pedestal by means of an Integrated Handle; and, the support Pedestal, comprised of a Face, Base and Dorsal Plate, where the Base and Dorsal Plate recess beneath and between the appliances, the Base Plate has a Tip Restraint at the rear, and the Face Plate provides access openings for appliance leveling. The invention may be produced using metal, synthetic materials, or a combination.

### CROSS REFERENCE TO RELATED APPLICATIONS (IF ANY)

None.

### STATEMENT OF FEDERALLY SPONSORED RESEARCH OR DEVELOPMENT (IF ANY)

None.

### THE NAMES OF THE PARTIES TO A JOINT RESEARCH AGREEMENT IF THE CLAIMED INVENTION WAS MADE AS A RESULT OF ACTIVITIES WITHIN THE SCOPE OF A JOINT RESEARCH AGREEMENT

None.

### REFERENCE TO A “SEQUENCE LISTING,” A TABLE, OR A COMPUTER PROGRAM LISTING APPENDIX SUBMITTED ON A COMPACT DISC AND AN INCORPORATION BY REFERENCE OF THE MATERIAL

None.

### BACKGROUND OF THE INVENTION

Residential laundry, done with Side-by-Side Front Loading Washer and Dryer appliances, has had an unsolved problem which this invention addresses, especially for differently-abled individuals. That problem is, how to move washed laundry between the Washer and the Dryer, across several feet of open air, when it is damp, heavy, bulky, lengthy, clinging, and/or entangled. Laundry is commonly in this state, after being spun-dry in the Washing machine, and will sag as a mass, drag, or fall when removed.

The inspiration to seek a solution to the problem came from personally moving wet laundry between a new, top of the line Washer, to the Dryer, with difficulty. How nice it would have been to have tray-drawers, or drop down ledges, on the appliances to help carry the items from one to the other. And, what about all those individuals, the young, the elderly, the differently abled, using existing Side by Side Front Loading Washers and Dryers? How do they cope? Could I create one for myself, and others?

Solution development began with identical, appliance-wide troughs set on the floor beneath the appliance doors. These evolved into a shorter, joined, open-ended trough, spanning beneath the two appliance drum doors. Ultimately, by modifying the trough edges to not obstruct door operation, the trough was elevated, and a Pedestal support evolved that recessed beneath and between the appliances. Features added to the trough made it removable from the Pedestal, for storage between uses. The resulting device, The Laundry Transfer Contour for Side by Side Front Loading Washers and Dryers, enables a person to remove washed laundry onto a support, where it can temporarily rest, unassisted and contained, and then be guided to the adjacent Dryer, where it is inserted.

The best mode for carrying out manufacture of the invention is expected to involve fabrication of the Pedestal components from metal, and the Transfer Contour portion molded from synthetic materials. However, the invention may be entirely one material, and one process, or a combination.

### BRIEF SUMMARY OF THE INVENTION

The Laundry Transfer Contour for Side by Side Front Loading Washers and Dryers assists individuals, especially the young, elderly, infirm, or differently-abled, in the manual transfer of laundry from the Washer, several feet across what was open air, to the Dryer when it is damp, heavy, bulky, lengthy, clingy, and/or entangled.

The invention is embodied by an elevated trough that spans the working distance beneath and between Washer and Dryer drum doors, without obstructing door operation, and is uniquely contoured to support, contain, and guide damp laundry in transit. The Laundry Transfer Contour has, inserts on, and removes from, a Pedestal that recesses beneath and between the appliances, whether the appliances are on the floor, or mounted on appliance drawer/cabinets.

The Pedestal's vertical Face Plate functions as a tongue onto which the Transfer Contour fits by means of a continuous three-sided groove embodied in the Transfer Contour back. When the Transfer Contour body is removed from the Pedestal, by means of an integrated Handle, Face Plate access openings are exposed that permit height adjustments of the appliance feet, leveling the appliances. A Tip Restraint is located at the rear of the Pedestal, and Removal Panels in the Base Plate permit adaptation to appliances mounted on appliance cabinets.

The invention components may be fabricated from metal, molded from synthetic material, or a combination.

### BRIEF DESCRIPTION OF THE SEVERAL VIEWS OF THE DRAWING (IF ANY)

FIG. 1, in Perspective format, depicts the Transfer Contour when mounted on the Pedestal Base, which is partially seen.

FIG. 2, in Elevation format, depicts the Transfer Contour as it would be seen in front of, and up against, a Front Loading Side by Side Washer and Dryer, while centered between the appliance doors.

FIG. 3, in Elevation format, depicts the Transfer Contour seen from the rear, with the Pedestal inserted within the continuous three-sided groove embodied in the back of the Transfer Contour. At the bottom of the drawing are shown the tops of the Access Openings in the Face Plate, partially hidden from view by the Trip Restraint Bar at the back of the Base Plate.

FIG. 4, in Plan format, depicts a top down view of the Transfer Contour mounted on the Pedestal. The trough area of the Transfer Contour, between Front and Rear Contour Edges shows the Clearance Contours for the Dryer and Washer Doors on the left and right. The Base Plate, Dorsal Plate and Tip Restraint are seen. On either side of the Dorsal Plate, on the Base Plate, are removable triangular Base Plate Panels and two holes for installing the Pedestal on those appliances that are situated on top of low-profile appliance cabinets. The Face Plate of the Pedestal is not in view because it is inserted within the Transfer Contour.

FIG. 5, in Detail View format, depicts the vertical nature of the Transfer Contour Rear Panel, the open-ended trough, the upward-curved contour of the Transfer Contour Front Panel, and the embodied continuous three-sided groove which secures the Pedestal Face Plate. At the rear of the Pedestal Base Plate is the Tip Restraint.

### DETAILED DESCRIPTION OF THE INVENTION

Front View

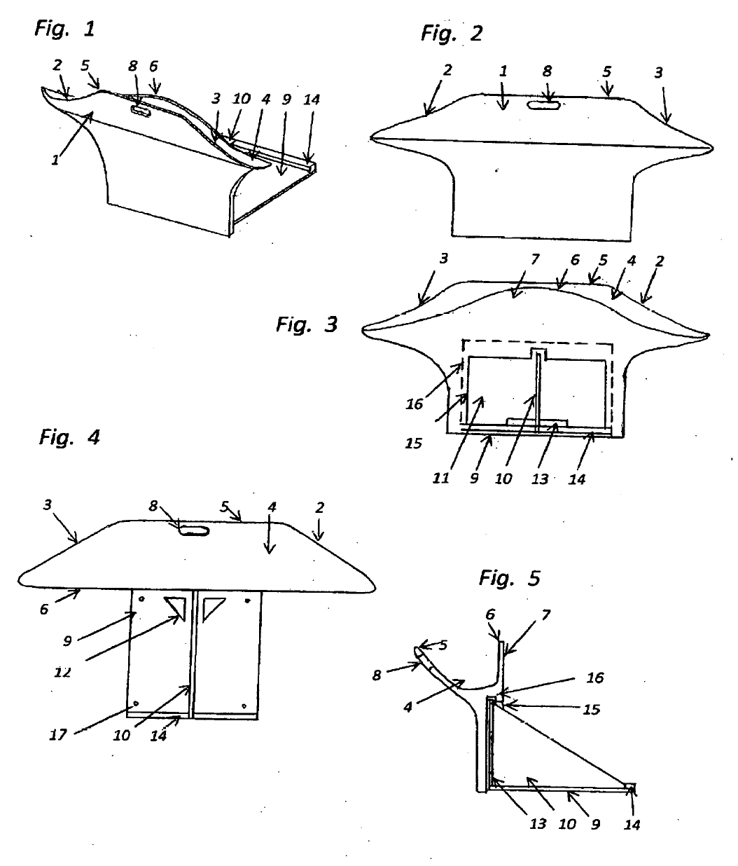

FIG. 1, in Perspective format, depicts the Transfer Contour Front Panel (1), when installed on the Pedestal. Installed, the Pedestal will be in front of the Washer and Dryer so that its Dorsal Plate (10) will recess between the adjacent sides of the appliances, its Base Plate (9) will be recessed beneath the center front feet of the appliances, and its Tip Restraint (14), will be beneath the appliance frames.

The Transfer Contour provides an open-ended Trough (4) formed between Front Edge (5) and Rear Edge (6). Washer Door Clearance Contour (2) on the left, and Dryer Door Clearance Contour (3) on the right permit the appliance doors to operate unobstructed. A Handle (8) embodied in the center top of the Front Panel (1) allows the Transfer Contour to be removed and replaced from the Pedestal.

FIG. 2, in Elevation format, depicts the Transfer Contour Front Panel (1), and Transfer Contour Front Edge (5), with Washer Door Clearance Contour (2) on the left, and Dryer Door Clearance Contour (3) on the right, permitting both the appliance doors to operate unobstructed. Handle (8) permits the Transfer Contour to be removed and replaced on the Pedestal Face Plate, not in view.

Rear View

FIG. 3, in Elevation format, depicts a rear view of the Pedestal with the Transfer Contour Rear Panel (7), inserted onto Pedestal Face Plate (11). The side and top of the Face Plate Edges (16) fit in a complementary groove embodied in the Transfer Contour Rear Panel (7) with Outside Edge (15).

When installed, from this view, the Transfer Contour Rear Panel (7) will be centered and flush against the front of the Dryer (left) and Washer (right) appliances. The Pedestal Dorsal Plate (10) will be recessed vertically between the adjacent appliance sides. The Pedestal Base Plate (9) will be recessed horizontally beneath both Dryer and Washer appliance feet. The Tip Restraint (14) will locate at the rear the Base Plate beneath both appliances.

The Transfer Contour Rear Edge (6), at its high point, approaches the height of Transfer Contour Front Edge (5). Between these edges is Transfer Contour Trough (4), which is open on both ends. Dryer Door Clearance Contour (3) on the left, and Washer Door Clearance Contour (2) on the right, permit the appliance doors to operate unobstructed by Transfer Contour Front Edge (6).

A Transfer Contour Handle, not in view, permits the Transfer Contour to be lifted off and replaced from the Pedestal Face Plate (11). The Pedestal Face Plate Access Openings (13) allow leveling the appliances by adjustment of the feet.

Top View

FIG. 4, in Plan format, depicts a top down view of Transfer Contour Trough (4) as it appears inserted onto the Pedestal Face Plate, not in view, and resting on the Base Plate (9). Transfer Contour Handle (8) permits the Transfer Contour to be lifted off and replaced, as necessary.

Transfer Contour Trough (4), has open ends with Dryer Door Clearance Contour (3) on the left, and Washer Door Clearance Contour (2) on the right. The Transfer Contour Front Edge (5), and Transfer Contour Rear Edge (6) rise on both sides of the Transfer Contour Trough (4) to contain support and guide laundry in transit from the Washer to the Dryer drum.

The Pedestal Base Plate (9) is integrated with the Pedestal Dorsal Plate (10), depicted on edge, and the Pedestal Face Plate, not in view. Tip Restraint (14) is located at the rear of the Base Plate (9), and four Fastener Holes (17) along with two removable Base Plate Corner Forms (12) permit installation of the floor mounted Pedestal to be adapted for mounting on low-profile appliance cabinets.

Side View

FIG. 5, in Detail View format, depicts a side view of the Transfer Contour inserted on the Pedestal. The Transfer Contour Front Edge (5), and Rear Edge (6), contain, support, and guide the Laundry moving through the Transfer Contour Trough (4) from the Washer to the Dryer.

The Transfer Contour may be lifted off the Pedestal Face Plate (11) and replaced by use of Transfer Contour Handle (8). This is possible by means of the Rear Panel (7) embodied Groove Edge (15), which surrounds the Pedestal Face Plate Edges (16) and holds the Face Plate (11). At the bottom of the Face Plate (11), Access Openings (13) allow the adjustment of the appliance feet to level the appliance. Pedestal Dorsal Plate (10) centers the Pedestal between the Washer and Dryer, and integrates with Face Plate (11) and Base Plate (9). Tip Restraint (14) is located at the rear of the Base Plate (9)

1. The laundry Transfer Contour is a device that assists differently-abled individuals in moving items from Side By Side Front Loading Washers to Dryers by supporting, containing and guiding damp laundry with contours that span the working distance beneath and between the appliance drum doors, while not obstructing door operation.

2. The Laundry Transfer Contour is supported on, and removable from, the Face Plate of a recessed Pedestal by means of an integrated Handle and Embodied Grooves.

3. The Pedestal, comprised of a Face, Base and Dorsal Plate, recesses between and beneath the Washer and Dryer, whether the appliances are floor or appliance-cabinet mounted, with Tip Restraint, Access Openings, Removable Corner Forms, and Fastener Hole features.
